(19) United States
(12) Patent Application Publication
(10) Pub. No.: US 2026/0299463 A1
(43) Pub. Date: Oct. 1, 2026

(54) DEVELOPING CARTRIDGE INCLUDING HOLDER HOLDING ELECTRICAL CONTACT SURFACE AND SUPPORTED BY GEAR COVER

(71) Applicant: BROTHER KOGYO KABUSHIKI KAISHA, Nagoya (JP)

(72) Inventors: Ryosuke HAYASHI, Nagoya (JP); Junya SUMIDA, Ama (JP); Ryuji NODA, Nagoya (JP)

(73) Assignee: BROTHER KOGYO KABUSHIKI KAISHA, Nagoya (JP)

(21) Appl. No.: 19/576,900

(22) Filed: Mar. 24, 2026

(30) Foreign Application Priority Data
Mar. 27, 2025 (JP) 2025-053757

(51) Int. Cl. G03G 15/08

(52) U.S. Cl. CPC G03G 15/087; G03G 15/0806; G03G 15/0863

(57) ABSTRACT

A developing cartridge includes: a developing roller rotatable about an axis extending in a first direction; a housing having a first outer surface in the first direction; a coupling; a gear; a cover covering the gear; and a memory having an electrical contact surface. The coupling, gear, and cover are positioned at the first outer surface. The gear and the electrical contact surface are positioned in the first direction between the first outer surface and an end of the coupling that is exposed through the cover. The gear is positioned between the developing roller and the electrical contact surface in a second direction crossing the electrical contact surface. The cover has an aperture positioned between the one end of the coupling and the first outer surface in the first direction. The aperture is positioned between the electrical contact surface and the coupling in the second direction.

### REFERENCE TO RELATED APPLICATIONS

This application claims priority from Japanese Patent Application No. 2025-053757 filed on Mar. 27, 2025. The entire content of the priority application is incorporated herein by reference.

### BACKGROUND ART

There has been known an image-forming apparatus of electro-photographic type, such as a laser printer and an LED printer. Such a known image-forming apparatus includes a developing cartridge and a drum cartridge. The developing cartridge is attachable to the drum cartridge. The drum cartridge is attachable to a main frame of the image-forming apparatus in a state where the developing cartridge is attached to the drum cartridge.

### SUMMARY

The developing cartridge described above includes a memory. When the drum cartridge to which the developing cartridge has been attached is attached to the main frame of the image-forming apparatus, an electrical contact surface of the memory is in contact with an electrode of the main frame to allow electrical communication between the memory and a controller of the main frame.

In view of the foregoing, it is an object of the present disclosure to improve the technique described above.

In order to attain the above and other object, according to one aspect, the present disclosure provides a developing cartridge including a developing roller, a housing, a coupling, a gear, a cover, and a memory. The developing roller is rotatable about a developing axis extending in a first direction. The housing stores toner. The housing has a first outer surface at one end of the housing in the first direction. The coupling is positioned at the first outer surface. The coupling has one end in the first direction. The gear is positioned at the first outer surface. The cover is positioned at the first outer surface and covers the gear. The memory has an electrical contact surface. The electrical contact surface is supported by the cover. The one end of the coupling is exposed through the cover. The gear and the electrical contact surface are positioned between the first outer surface and the one end of the coupling in the first direction. The gear is positioned between the developing roller and the electrical contact surface in a second direction crossing the electrical contact surface. The gear and the electrical contact surface are spaced apart from each other. The cover has an aperture positioned between the one end of the coupling and the first outer surface in the first direction. The aperture is positioned between the electrical contact surface and the coupling in the second direction.

This structure can improve the technique disclosed in the above-mentioned prior art.

Further, since the aperture is positioned between the electrical contact surface and the coupling in the second direction, the cover can be restrained from interfering with a drum cartridge or an image-forming apparatus upon attachment of the developing cartridge to the drum cartridge or the image-forming apparatus.

### BRIEF DESCRIPTION OF DRAWINGS

FIG. 1 is a perspective view of a developing cartridge and a drum cartridge.

FIG. 2 is a perspective view of the developing cartridge.

FIG. 3 is another perspective view of the developing cartridge as viewed in a different direction from FIG. 2.

FIG. 4 is a partially enlarged view of a region near a gear section in the developing cartridge.

FIG. 5 is a view of the developing cartridge as viewed from a perspective outside of the gear section in a first direction.

FIG. 6 is a cross-sectional view of the developing cartridge.

FIG. 7 is a cross-sectional view of the developing cartridge and the drum cartridge in a state where the developing cartridge is attached to the drum cartridge.

FIG. 8 is a view illustrating the region near the gear section as viewed in a second direction.

FIG. 9 is a view illustrating the region near the gear section as viewed in a third direction.

FIG. 10 is a perspective view illustrating a gear section in a developing cartridge according to a second embodiment.

FIG. 11 is a perspective view of the developing cartridge according to the second embodiment as viewed from a perspective outside of the gear section in the first direction.

FIG. 12 is a perspective view illustrating a gear section in a developing cartridge according to a third embodiment.

FIG. 13 is a perspective view of the developing cartridge according to the third embodiment as viewed from a perspective outside of the gear section in the first direction.

FIG. 14 is a cross-sectional view of the developing cartridge according to the third embodiment.

FIG. 15 is a cross-sectional view of a developing cartridge according to a modification to the third embodiment.

### DESCRIPTION

Hereinafter, various embodiments of the present disclosure will be described with reference to accompanying drawings.

In the following description, directions will be referred to using a first direction, a second direction, and a third direction. Specifically, a direction in which a developing axis L2 (a rotational axis of a developing roller 30) extends will be defined as “first direction.” A direction crossing electrical contact surfaces 91 will be defined as “second direction.” Further, a direction in which a protrusion 65 of a drum frame 60 protrudes will be defined as “third direction.”

The second direction crosses the first direction. For example, the second direction is orthogonal to the first direction. The third direction also crosses the first direction. For example, the third direction is orthogonal to the first direction. The second direction crosses the third direction. For example, the second direction is orthogonal to the third direction.

### 1. First Embodiment

### 1-1. Overview of Developing Cartridge and Drum Cartridge

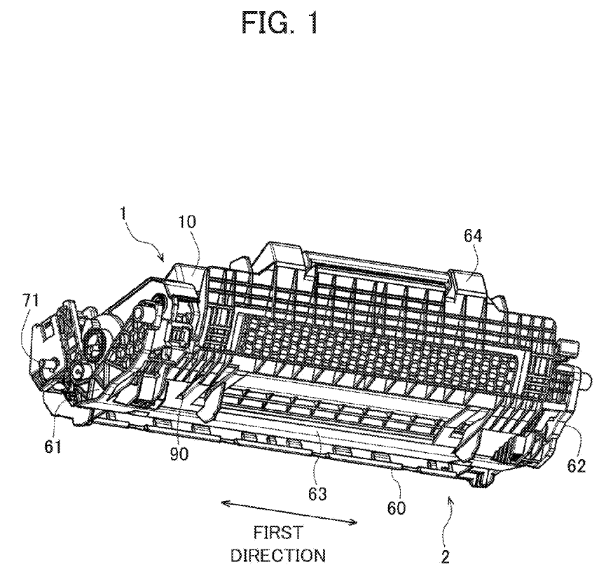

FIG. 1 is a perspective view of a developing cartridge 1 and a drum cartridge 2 according to a first embodiment of the disclosure. The developing cartridge 1 and the drum cartridge 2 are for use in an image-forming apparatus of electrophotographic type. The image-forming apparatus is a laser printer or an LED printer, for example.

As illustrated in FIG. 1, the developing cartridge 1 is attachable to and detachable from the drum cartridge 2. In a state where the developing cartridge 1 is attached to the drum cartridge 2, the drum cartridge 2 is attachable to and detachable from a main frame of the image-forming apparatus. The image-forming apparatus is configured to form an image on a sheet using toner supplied from the developing cartridge 1.

1-2. Developing Cartridge

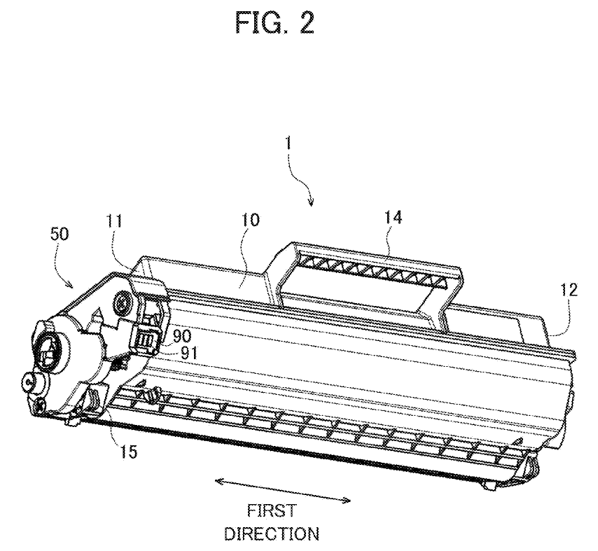

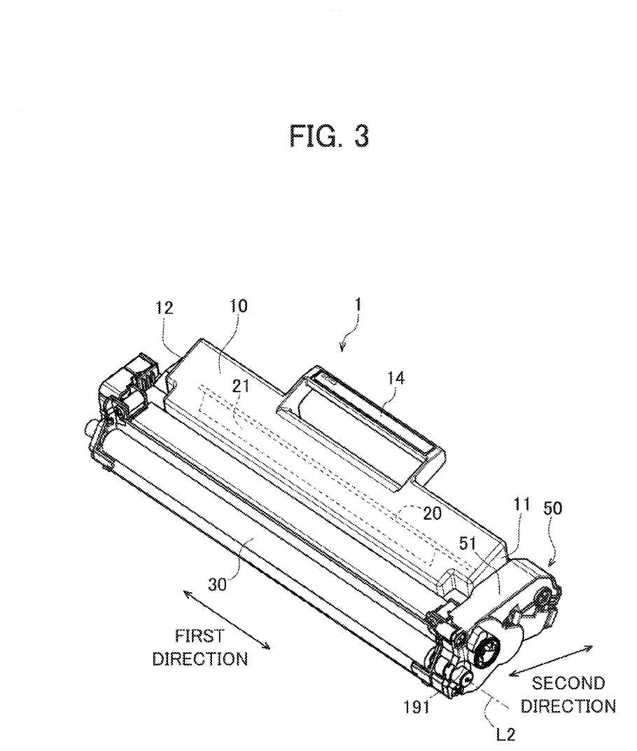

FIG. 2 is a perspective view of the developing cartridge 1. FIG. 3 is another perspective view of the drum cartridge 2 as viewed in a different direction from FIG. 2. As illustrated in FIGS. 2 and 3, the developing cartridge 1 includes a housing 10, an agitator 20, a developing roller 30, a gear section 50, and a memory 90.

The housing 10 is a container configured to store toner as a developer. The housing 10 has a first outer surface 11 and a second outer surface 12. The first outer surface 11 is positioned at one end of the housing 10 in the first direction. The second outer surface 12 is positioned at the other end of the housing 10 in the first direction. The first outer surface 11 and the second outer surface 12 are spaced apart from each other in the first direction. The housing 10 also includes a toner handle 14. The toner handle 14 is positioned at one end of the housing 10 in the second direction.

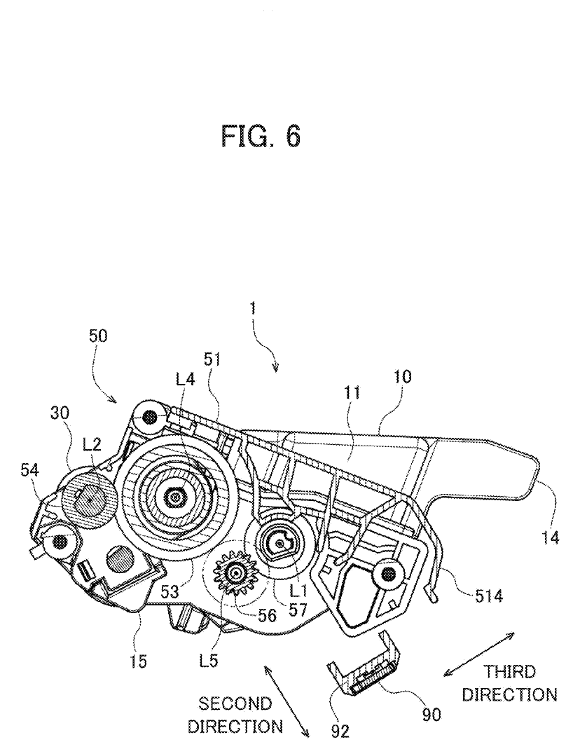

The agitator 20 is disposed inside the housing 10. As illustrated in FIG. 3, the agitator 20 includes a fin 21. The agitator 20 is rotatable about an agitator axis L1 (see FIG. 6) extending in the first direction. As the agitator 20 rotates about the agitator axis L1, the toner within the housing 10 is agitated by the fin 21.

The developing roller 30 is rotatable about a developing axis L2 (see FIG. 6) extending in the first direction. The developing roller 30 is supported by the housing 10. The 30. The developing roller 30 is positioned at the other end of the housing 10 in the second direction. The developing roller 30 has an outer peripheral surface of a cylindrical shape extending in the first direction. A part of the outer peripheral surface of the developing roller 30 is exposed outside the housing 10. The toner within the housing 10 is configured to be supplied onto the outer peripheral surface of the developing roller 30 via a supply roller (not illustrated). The toner is thus carried on the outer peripheral surface of the developing roller 30.

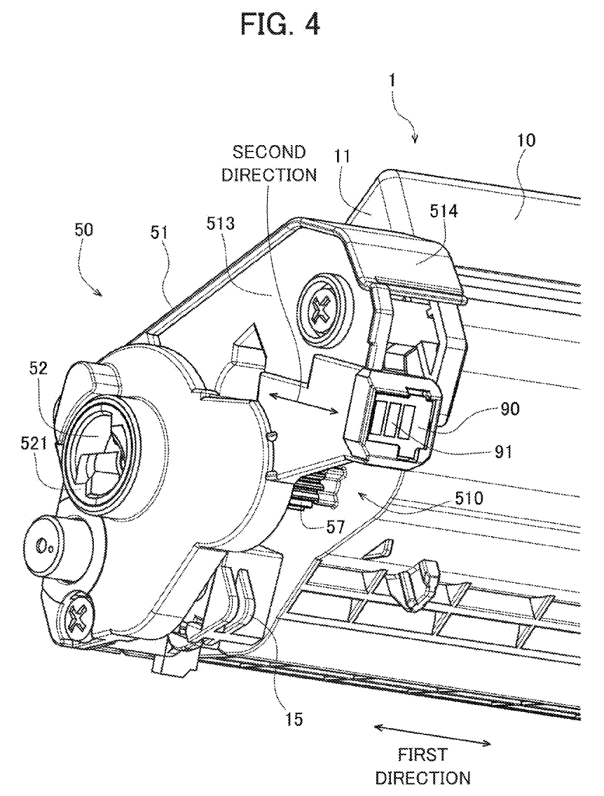

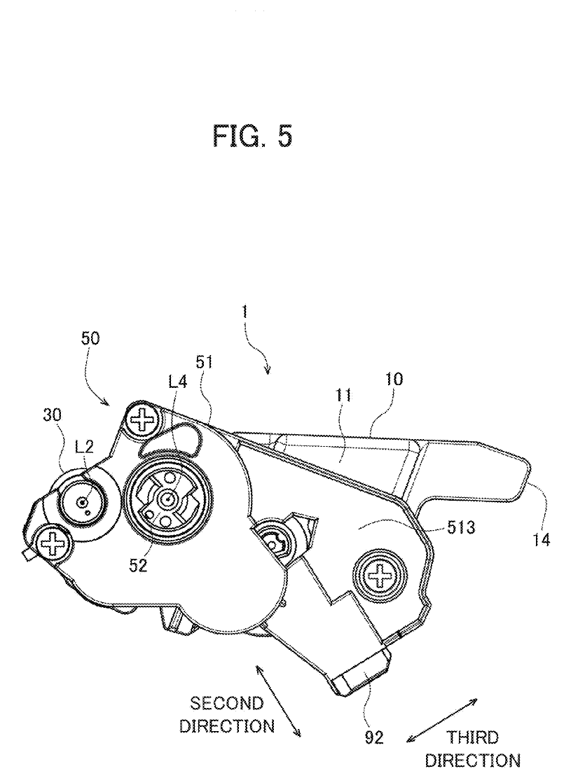

The gear section 50 is positioned at the first outer surface 11 of the housing 10. FIG. 4 is partially enlarged perspective view near the gear section 50 of the developing cartridge 1. FIG. 5 is a view of the gear section 50 of the developing cartridge 1 as viewed from outside thereof in the first direction. As illustrated in FIGS. 4 and 5, the gear section 50 includes a cover 51, a coupling 52, and a plurality of gears.

The cover 51 is mounted at the first outer surface 11 of the housing 10. Specifically, the cover 51 is screw-fixed to the first outer surface 11. The plurality of gears is positioned between the first outer surface 11 and the cover 51 in the first direction. That is, the plurality of gears is covered by the cover 51.

The coupling 52 is rotatable about a coupling axis L4 extending in the first direction. One end 521 of the coupling 52 in the first direction is exposed outside the cover 51. When the drum cartridge 2 to which the developing cartridge 1 is attached is attached to the main frame of the image-forming apparatus, a drive shaft of the main frame is inserted in and coupled to the coupling 52. This coupling between the drive shaft and the coupling 52 enables the coupling 52 to rotate about the coupling axis L4 together with the drive shaft. In the image-forming apparatus, a drive force can be thus transmitted to the plurality of gears via the coupling 52.

FIG. 6 is a cross-sectional view of the developing cartridge 1. FIG. 6 illustrates a cross-section of the developing cartridge 1 taken along a plane passing through the gear section 50 and orthogonal to the first direction. As illustrated in FIG. 6, the plurality of gears in the gear section 50 includes a coupling gear 53, a developing roller gear 54, an idle gear 56, and an agitator gear 57.

The coupling gear 53 is positioned at the first outer surface 11 of the housing 10. The coupling gear 53 is positioned inside of the cover 51. The coupling 52 and the coupling gear 53 are formed as a single member. Accordingly, the coupling gear 53 is configured to rotate about the coupling axis L4 together with the coupling 52. The coupling gear 53 has an outer circumference along an entire length of which gear teeth are formed. Incidentally, in FIG. 6, the gear teeth of the coupling gear 53 are not depicted.

The developing roller gear 54 is positioned at the first outer surface 11 of the housing 10. The developing roller gear 54 is positioned inside of the cover 51. The developing roller gear 54 is connected to one end of the developing roller 30 in the first direction. The developing roller gear 54 has an outer circumference along an entire length of which gear teeth are formed. Incidentally, in FIG. 6, the gear teeth of the developing roller gear 54 are not depicted.

The developing roller gear 54 meshes with the coupling gear 53. The developing roller gear 54 rotates in accordance with rotation of the coupling gear 53. As the developing roller gear 54 rotates, the developing roller 30 also rotates about the developing axis L2 together with the developing roller gear 54.

The idle gear 56 is positioned at the first outer surface 11 of the housing 10. The idle gear 56 is positioned inside of the cover 51. The idle gear 56 is positioned between the agitator gear 57 and a pressing surface 15 (described later) in the third direction. The idle gear 56 is rotatable about an idle axis L5 extending in the first direction. The idle gear 56 meshes with the coupling gear 53. The idle gear 56 rotates in accordance with rotation of the coupling gear 53.

The agitator gear 57 is positioned at the first outer surface 11 of the housing 10. The agitator gear 57 is positioned inside of the cover 51. The agitator gear 57 is connected to one end of the agitator 20 in the first direction. The agitator gear 57 has an outer circumference along an entire length of which gear teeth are formed. Incidentally, the gear teeth of the agitator gear 57 are not depicted in the attached drawings.

The agitator gear 57 meshes with the idle gear 56. The agitator gear 57 rotates following the rotation of the idle gear 56. As the agitator gear 57 rotates, the agitator 20 also rotates about the agitator axis L1 together with the agitator gear 57.

The memory 90 is a storage medium storing information on the developing cartridge 1. The memory 90 is positioned at one end portion of the housing 10 in the first direction. The memory 90 is an IC chip, for example. The memory 90 stores at least one of identification information and lifetime information regarding the developing cartridge 1. The identification information is information for identifying the developing cartridge 1, for example, a product serial number of the developing cartridge 1. The lifetime information is information indicative of service life of the developing cartridge 1. For example, the lifetime information is the accumulated number of rotations of the developing roller 30.

The memory 90 has electrical contact surfaces 91. Each of the electrical contact surfaces 91 is a surface made of metal as an electrical conductor. The electrical contact surfaces 91 are electrically connected to a storage element of the memory 90. Each of the electrical contact surfaces 91 is a surface crossing the second direction. For example, each of the electrical contact surfaces 91 is a surface orthogonal to the second direction. In the state where the developing cartridge 1 is attached to the drum cartridge 2, the electrical contact surfaces 91 are exposed outside a drum frame 60 of the drum cartridge 2. When the drum cartridge 2 is attached to the main frame of the image-forming apparatus with the developing cartridge 1 attached to the drum cartridge 2, the electrical contact surfaces 91 are in contact with an electrode of the main frame of the image-forming apparatus. A controller (not illustrated) of the image-forming apparatus can thus communicate with the memory 90 of the developing cartridge 1.

### 1-3. Drum Cartridge

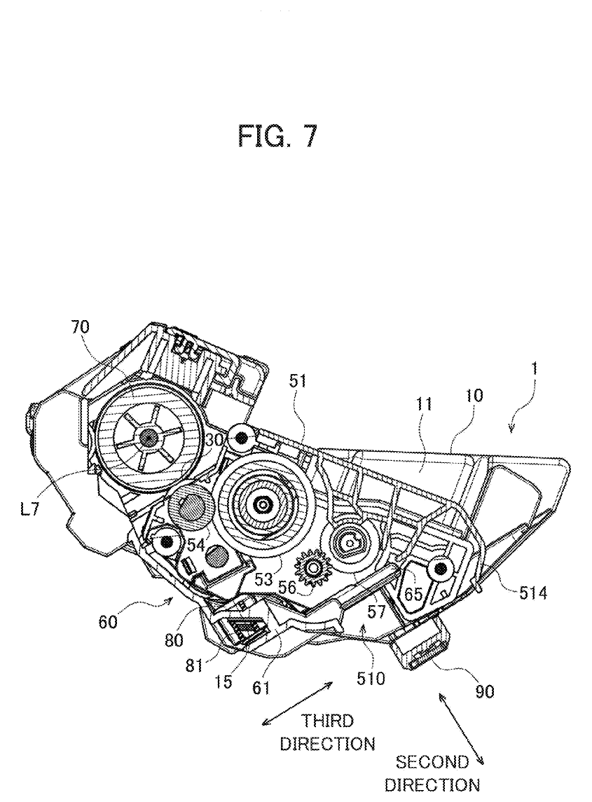

FIG. 7 is a cross-sectional view of the developing cartridge 1 and the drum cartridge 2 in the state where the developing cartridge 1 is attached to the drum cartridge 2. FIG. 7 is a cross-section of the developing cartridge 1 and the drum cartridge 2 taken along a plane passing through the gear section 50 and orthogonal to the first direction. As illustrated in FIGS. 1 and 7, the drum cartridge 2 includes the drum frame 60, a photosensitive drum 70, and a pressing member 80.

The drum frame 60 includes a first side frame 61, a second side frame 62, a connecting frame 63, and a drum handle 64. The first side frame 61 is positioned at one end portion of the drum frame 60 in the first direction. The second side frame 62 is the other end portion of the drum frame 60 in the first direction. The first side frame 61 and the second side frame 62 are spaced apart from each other in the first direction. The connecting frame 63 connects the first side frame 61 to the second side frame 62 in the first direction. The drum handle 64 is positioned at one end portion of the drum frame 60 in the second direction.

The developing cartridge 1 is attachable to and detachable from the drum frame 60. In the state where the developing cartridge 1 is attached to the drum cartridge 2, the developing cartridge 1 is positioned between the first side frame 61 and the second side frame 62 in the first direction.

The photosensitive drum 70 is rotatable about a drum axis L7 extending in the first direction. The photosensitive drum 70 is supported by the drum frame 60. The photosensitive drum 70 is positioned between the first side frame 61 and the second side frame 62 in the first direction. The photosensitive drum 70 is positioned at the other end portion of the drum frame 60 in the second direction.

The photosensitive drum 70 has an outer peripheral surface of a cylindrical shape. The outer peripheral surface of the photosensitive drum 70 is covered with a photosensitive material. The photosensitive drum 70 is configured to receive a drive force from the image-forming apparatus in the state where the developing cartridge 1 is attached to the drum cartridge 2. Specifically, the photosensitive drum 70 includes a drum gear positioned at an end portion of the photosensitive drum 70 adjacent to the first side frame 61 (one end portion of the drum frame 60 in the first direction). In a state where the drum cartridge 2 is attached to the main frame of the image-forming apparatus, the drum gear meshes with a gear of the main frame to receive a drive force therefrom, thereby rotating the photosensitive drum 70 about the drum axis L7.

The photosensitive drum 70 includes a drum shaft 71, as illustrated in FIG. 1. The drum shaft 71 protrudes outward from each end portion (one end and the other end portions) of the photosensitive drum 70. The drum shaft 71 is configured to be guided by grooves formed in the main frame during attachment of the drum cartridge 2 to the main frame of the image-forming apparatus. The drum shaft 71 is in contact with a ground electrode of the main frame of the image-forming apparatus in the state where the drum cartridge 2 is attached to the main frame of the image-forming apparatus.

As illustrated in FIG. 7, the developing roller 30 and the photosensitive drum 70 are aligned with each other in a state where the developing cartridge 1 is attached to the drum frame 60. Specifically, the outer peripheral surface of the developing roller 30 and the outer peripheral surface of the photosensitive drum 70 are in contact with each other in the state where the developing cartridge 1 is attached to the drum frame 60.

The toner is to be supplied from the outer peripheral surface of the developing roller 30 to the outer peripheral surface of the photosensitive drum 70. At this time, the toner is to move from the developing roller 30 to the photosensitive drum 70 based on an electrostatic latent image formed on the outer peripheral surface of the photosensitive drum 70. A toner image is thus formed on the outer peripheral surface of the photosensitive drum 70. Thereafter, the toner image is to be transferred from the photosensitive drum 70 to a printing sheet.

The pressing member 80 is configured to press the developing cartridge 1 toward the photosensitive drum 70 in the state where the developing cartridge 1 is attached to the drum cartridge 2. As illustrated in FIG. 7, the pressing member 80 is mounted on the first side frame 61. The drum cartridge 2 further includes a pressing spring 81. The pressing spring 81 is interposed between the pressing member 80 and the first side frame 61.

On the other hand, as illustrated in FIGS. 4, 6 and 7, the housing 10 of the developing cartridge 1 has the pressing surface 15. The pressing surface 15 extends from the first outer surface 11 of the housing 10, in the first direction toward the outside of the housing 10. With respect to the second direction, the pressing surface 15 protrudes in a direction way from the developing roller 30. In the state where the developing cartridge 1 is attached to the drum cartridge 2, the pressing member 80 is in contact with the pressing surface 15 of the developing cartridge 1. The pressing member 80 urges the pressing surface 15 toward the photosensitive drum 70 by an urging force of the pressing spring 81. The developing roller 30 and the photosensitive drum 70 are thus made in contact with each other.

### 1-4. Structure for Supporting the Electrical Contact Surfaces

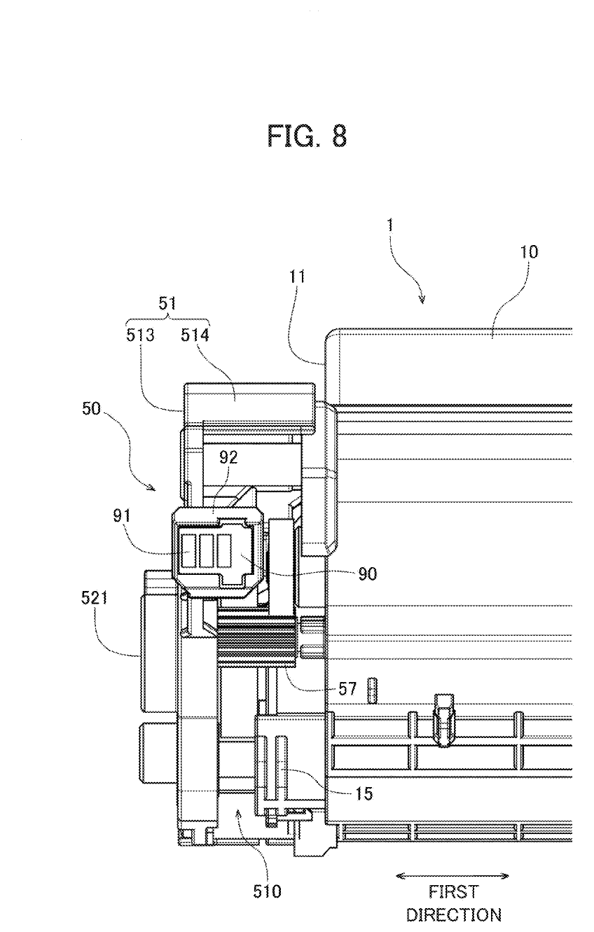

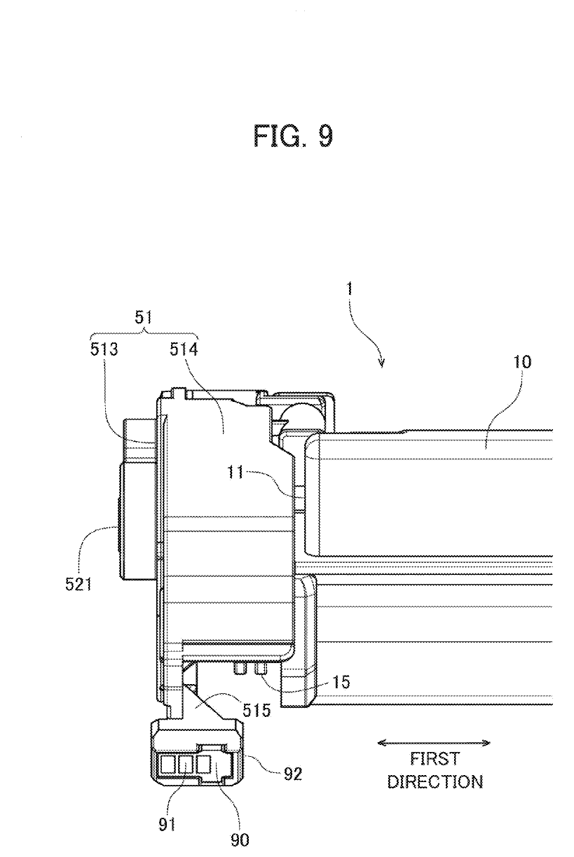

A structure for supporting the memory 90 in the developing cartridge 1 will be described next. FIG. 8 is a view of a region near the gear section 50 of the developing cartridge 1 as viewed in the second direction. FIG. 9 is a view of a region near the gear section 50 of the developing cartridge 1 as viewed in the third direction.

As illustrated in FIGS. 4, 8 and 9, the memory 90 is supported by the cover 51. Hence, the electrical contact surfaces 91 are supported by the cover 51. In the present embodiment, an entirety of the memory 90 having the electrical contact surfaces 91 is supported by the cover 51. Alternatively, only the electrical contact surfaces 91 in the memory 90 may be supported by the cover 51, whereas the storage element of the memory 90 may be supported by a part of the developing cartridge 1 other than the cover 51. In this case, the electrical contact surfaces 91 and the storage element of the memory 90 may be electrically connected to each other via wirings.

The plurality of gears in the gear section 50 and the electrical contact surfaces 91 are both positioned between the one end 521 in the first direction of the coupling 52 and the housing 10 of the housing 10 in the first direction. For example, the agitator gear 57 and the electrical contact surfaces 91 are positioned between the one end 521 in the first direction of the coupling 52 and the first outer surface 11 of the housing 10 in the first direction. This arrangement can reduce the dimension of the developing cartridge in the first direction.

With respect to the position in the first direction, the plurality of gears in the gear section 50 and the electrical contact surfaces 91 overlap each other, at least partially. In the present embodiment, the agitator gear 57 and the electrical contact surfaces 91 are arranged at the same position as each other in the first direction. This arrangement can reduce the dimension of the developing cartridge in the first direction, compared to an arrangement where the agitator gear 57 and the electrical contact surfaces 91 are arranged at different locations from each other in the first direction.

Among the plurality of gears in the gear section 50, at least a part of the gears is positioned between the developing roller 30 and the electrical contact surfaces 91 in the second direction. For example, the agitator gear 57 is positioned between the developing roller 30 and the electrical contact surfaces 91 in the second direction. Further, the plurality of gears in the gear section 50 and the electrical contact surfaces 91 are arranged to be spaced apart from each other. For example, the agitator gear 57 and the electrical contact surfaces 91 are spaced apart from each other.

As illustrated in FIGS. 4, 8 and 9, the cover 51 includes an end wall 513, a peripheral wall 514, and a holder 92. The end wall 513 extends in a direction crossing the first direction. The end wall 513 opposes the first outer surface 11 of the housing 10 in the first direction. The peripheral wall 514 extends, from an outer peripheral portion of the end wall 513, toward the first outer surface 11 of the housing 10 in the first direction. The holder 92 is connected to one end of the end wall 513 in the second direction. The memory 90 having the electrical contact surfaces 91 is positioned at an outer surface of the holder 92.

In the present embodiment, the end wall 513, the peripheral wall 514 and the holder 92 supporting the memory 90 are formed as a single member. This structure can reduce the number of parts for the developing cartridge 1, compared to a structure where the holder 92, the end wall 513 and the peripheral wall 514 are provided as separate members from each other.

As illustrated in FIG. 9, the cover 51 includes a rib 515. The rib 515 extends from the one end of the end wall 513 in the second direction, toward the housing 10 in the first direction. The holder 92 is connected to the end wall 513 and to the rib 515. Hence, the holder 92 is supported by the end wall 513 and the rib 515. This structure can restrain the holder 92 from being deformed or displaced relative to the end wall 513.

The holder 92 protrudes in the second direction from an outer surface of the cover 51. When the developing cartridge 1 is viewed in the first direction from the second outer surface 12, at least a part of the holder 92 is positioned outside the housing 10. That is, when the developing cartridge 1 is viewed in the first direction from the second outer surface 12, at least a part of the holder 92 protrudes outward relative to an outer contour of the housing 10. With this configuration, when the developing cartridge 1 is viewed in the first direction from the second outer surface 12, the holder 92 and the plurality of gears in the gear section 50 can be arranged in a wider space than a configuration where an entirety of the holder 92 is arranged within the outer contour of the housing 10.

As illustrated in FIG. 4, the cover 51 has an aperture 510. The aperture 510 is a through-hole that extends through a part of the peripheral wall 514 in the second direction. That is, the aperture 510 is a part of an outer peripheral portion of the cover 51 other than the peripheral wall 514. The aperture 510 may not be enclosed only by the cover 51. In other words, the aperture 510 in the cover 51 may be defined by both a part of the cover 51 and the first outer surface 11 of the housing 10. The cover 51 is arranged between the electrical contact surfaces 91 and the developing roller 30 in the second direction.

The aperture 510 is positioned between the one end 521 of the coupling 52 and the first outer surface 11 of the housing 10 in the first direction. In the second direction, the aperture 510 is positioned between the electrical contact surfaces 91 and the coupling 52.

As illustrated in FIGS. 8 and 9, the electrical contact surfaces 91 has a part at the same position as the end wall 513 in the first direction. Further, in a remaining part of the electrical contact surfaces 91 other than the part at the same position as the end wall 513 in the first direction, at least a part of the remaining part of the electrical contact surfaces 91 is at the same position as the aperture 510 in the first direction.

At least a part of the gears in the gear section 50 is exposed to the outside of the cover 51 in the second direction through the aperture 510 in a region between the end wall 513 and the first outer surface 11 in the first direction. In the present embodiment, the agitator gear 57 is exposed to the outside of the cover 51 in the second direction through the aperture 510 in the region between the end wall 513 and the first outer surface 11 in the first direction.

In the state where the developing cartridge 1 is attached to the drum cartridge 2, a part of the drum cartridge 2 is inserted in the aperture 510. Hence, this part of the drum cartridge 2 is restricted from making contact with the cover 51.

Specifically, as illustrated in FIG. 7, the drum frame 60 includes a protrusion 65. The protrusion 65 extends in the third direction from the first side frame 61. The protrusion 65 protrudes in a direction away from the pressing member 80 in the third direction. When the developing cartridge 1 is attached to the drum cartridge 2, the protrusion 65 is inserted inside the cover 51 through the aperture 510. That is, the protrusion 65 is inserted in the region between the first outer surface 11 of the housing 10 and the end wall 513 of the cover 51 upon attachment of the developing cartridge 1 to the drum cartridge 2, thereby restraining the cover 51 from contacting the protrusion 65. In other words, interference between the cover 51 and the protrusion 65 is less likely to occur.

In the state where the developing cartridge 1 is attached to the drum cartridge 2, the protrusion 65 is positioned between the electrical contact surfaces 91 of the memory 90 and the plurality of gears of the gear section 50 in the second direction. More specifically, in the state where the developing cartridge 1 is attached to the drum cartridge 2, the protrusion 65 is positioned between the electrical contact surfaces 91 and the agitator gear 57 in the second direction.

Further, as illustrated in FIG. 8, the pressing surface 15 is exposed to the outside of the cover 51 through the aperture 510 in the region between the end wall 513 and the first outer surface 11 of the housing 10 in the first direction. As such, the pressing member 80 of the drum cartridge 2 can contact the pressing surface 15 of the developing cartridge 1 in the state where the developing cartridge 1 is attached to the drum cartridge 2.

### 2. Second Embodiment

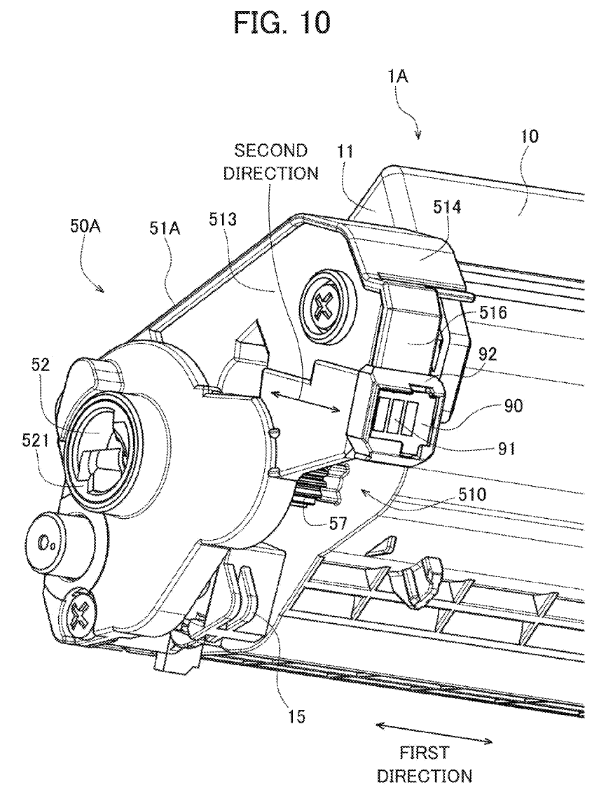

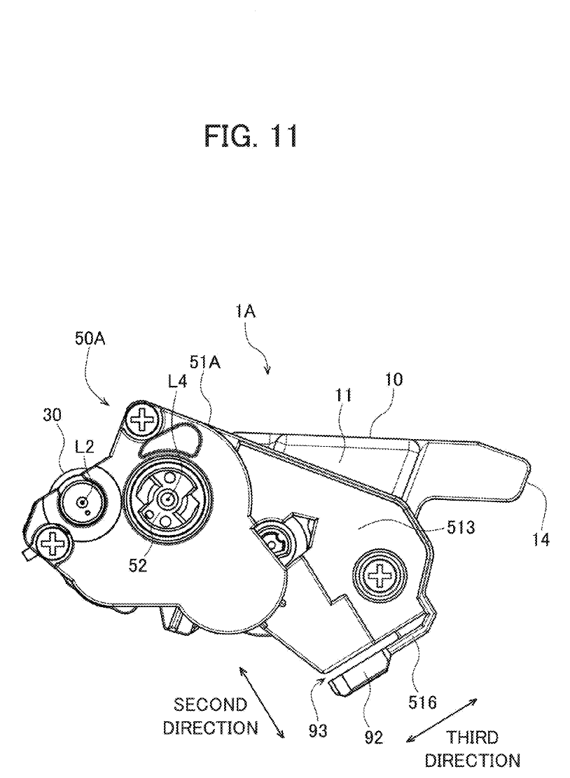

Next, a developing cartridge 1A according to a second embodiment of the disclosure will be described with reference to FIGS. 10 and 11. In the following description, like parts and components similar to those of the first embodiment are designated by the same reference numerals as those in the first embodiment to avoid duplicating description.

FIG. 10 is a partially-enlarged perspective view of a region near a gear section 50A of the developing cartridge 1A according to the second embodiment. FIG. 11 is a view of the developing cartridge 1A as viewed in the first direction from a perspective outside of the gear section 50A.

In the first embodiment, the holder 92 is connected to the one end in the second direction of the end wall 513 of the cover 51. However, in a cover 51A according to the second embodiment, the cover 51A includes an arm 516 that supports the holder 92 as illustrated in FIGS. 10 and 11. The arm 516 extends from a part of the peripheral wall 514 toward the aperture 510. The holder 92 is connected to a free end of the arm 516. As illustrated in FIG. 11, a gap 93 is formed between the end wall 513 and the holder 92 in the second direction.

The arm 516 has a plate-shape extending in a direction crossing the second direction. Specifically, in the present embodiment, the arm 516 extends in the third direction crossing the second direction. As such, the arm 516 is deformable in the second direction. Further, since the holder 92 is positioned at the free end of the arm 516, deformation of the arm 516 enables the electrical contact surfaces 91 supported by the holder 92 to move in the second direction. The electrical contact surfaces 91 are thus restrained from being rubbed while making contact with electrodes of the image-forming apparatus.

Incidentally, while the arm 516 extends in the third direction in the present embodiment, the arm 516 may extend in a direction other than the third direction as long as the direction crosses the second direction. For example, the arm 516 may extend in the first direction.

### 3. Third Embodiment

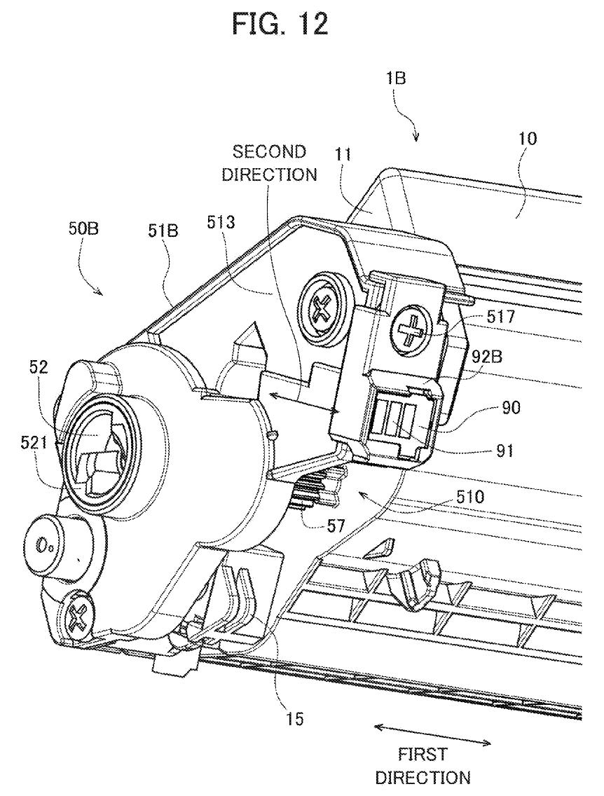

Next, a developing cartridge 1B according to a third embodiment of the disclosure will be described with reference to FIGS. 12-14. In the following description, like parts and components similar to those of the first and second embodiments are designated by the same reference numerals as those in the first and second embodiments to avoid duplicating description.

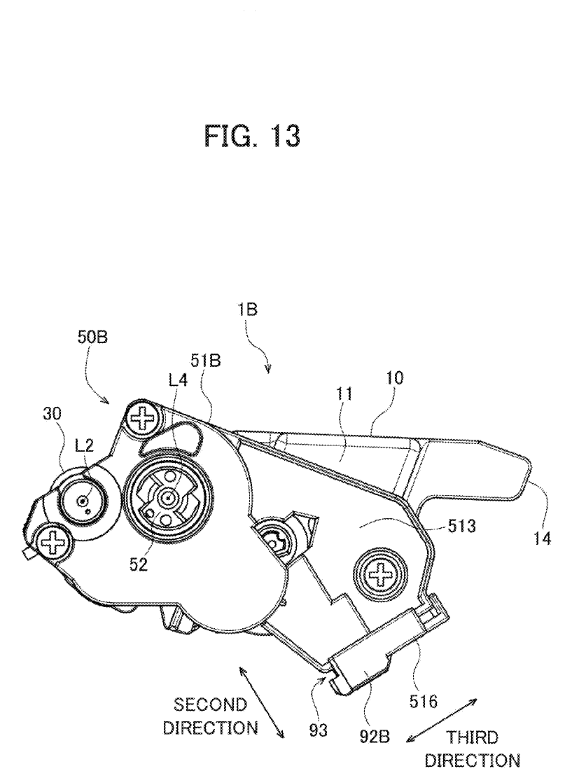

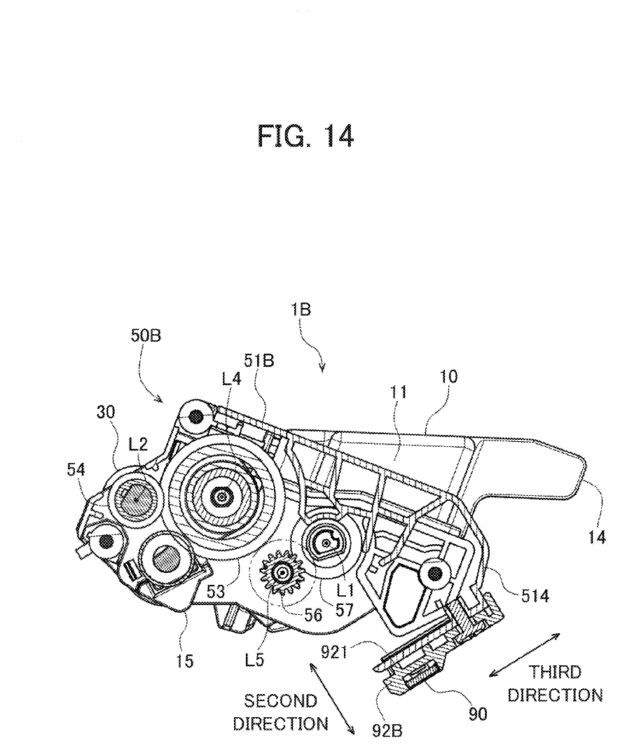

FIG. 12 is a partially-enlarged perspective view of a region near a gear section 50B in the developing cartridge 1B according to the third embodiment. FIG. 13 is a view of the developing cartridge 1B as viewed in the first direction from a perspective outside of the gear section 50B. FIG. 14 is a cross-sectional view of the developing cartridge 1B according to the third embodiment taken along a plane passing through the gear section 50B and perpendicular to the first direction.

In the above-described embodiments, the holder 92 is formed as a single member together with the end wall 513 and the peripheral wall 514 in the cover 51, 51A. In contrast, in a cover 51B according to the third embodiment, a holder 92B is formed as a separate member from the end wall 513 and the peripheral wall 514. The holder 92B is fixed to the peripheral wall 514 of the cover 51 by a screw 517. By forming the holder 92B as a separate member from the end wall 513 and peripheral wall 514 in this way, forming each part of the cover 51B can be made easier.

Further, as illustrated in FIG. 14, the holder 92B includes a protrusion 921. The protrusion 921 protrudes toward the peripheral wall 514 from a surface of the holder 92B facing the peripheral wall 514. The protrusion 921 has a protruding end in contact with an outer peripheral surface of the peripheral wall 514 in the second direction. With this configuration, the holder 92B is restricted from being deformed or displaced in the second direction.

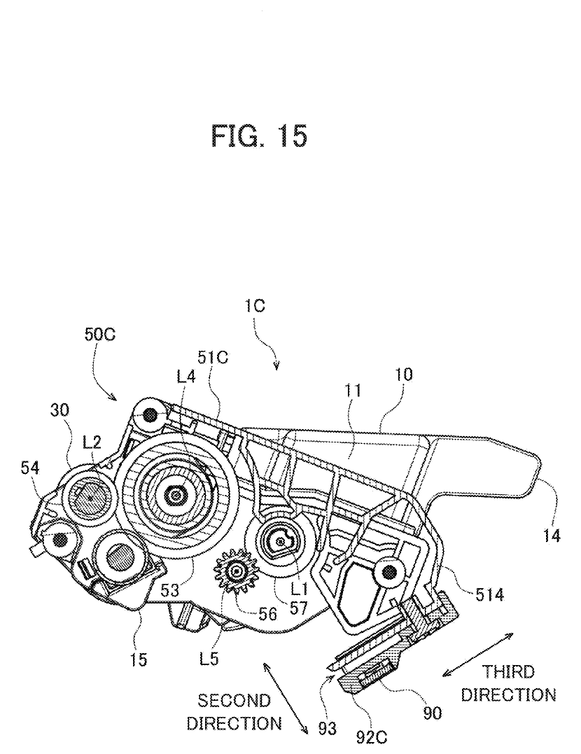

FIG. 15 is a cross-sectional view of a developing cartridge 1C according to a modification to the third embodiment taken along a plane passing through a gear section 50C and perpendicular to the first direction.

In a cover 51C according to this modification to the third embodiment, a holder 92C does not have a protrusion like the protrusion 921. The holder 92C extends in the third direction crossing the second direction. The gap 93 is formed between the holder 92C and the peripheral wall 514. Hence, deformation of the holder 92C enables the electrical contact surfaces 91 supported by the holder 92C to move in the second direction. The electrical contact surfaces 91 are thus restrained from being rubbed while making contact with electrodes of the image-forming apparatus.

### 4. Other Modifications and Variations

While the invention has been described in conjunction with various example structures (first to third embodiments) outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described first to third embodiments, the pressing surface 15 protrudes in the direction away from the developing roller 30 in the second direction. However, the pressing surface 15 may not protrude in the direction away from the developing roller 30 in the second direction. For example, the pressing surface 15 may be a flat surface. Alternatively, the pressing surface 15 may be recessed toward the developing roller 30 in the second direction.

The gear section of the disclosure need not have the same configurations as those in the gear section 50, 50A, 50B, 50C according to the above-described first to third embodiments. The number of the gears, positions of the gears, kinds of the gears, shapes of the gears in the gear section of the disclosure may be modified as appropriate without departing from the technical concept of the disclosure.

In the above-described first to third embodiments, the cover 51, 51A, 51B, 51C has the aperture 510. However, the cover of the disclosure may not have the aperture 510.

Each and every element described in the above embodiments and modifications may be combined or omitted partially, as appropriate, as long as no contradiction arises.

What is claimed is:

1. A developing cartridge comprising:
a developing roller rotatable about a developing axis extending in a first direction;
a housing storing toner, the housing having a first outer surface at one end of the housing in the first direction;
a coupling positioned at the first outer surface, the coupling having one end in the first direction;
a gear positioned at the first outer surface;
a cover positioned at the first outer surface and covering the gear; and
a memory having an electrical contact surface, the electrical contact surface being supported by the cover,
wherein
the one end of the coupling is exposed through the cover,
the gear and the electrical contact surface are positioned between the first outer surface and the one end of the coupling in the first direction,
the gear is positioned between the developing roller and the electrical contact surface in a second direction crossing the electrical contact surface,
the gear and the electrical contact surface are spaced apart from each other, and
the cover has an aperture positioned between the one end of the coupling and the first outer surface in the first direction, the aperture being positioned between the electrical contact surface and the coupling in the second direction.

2. The developing cartridge according to claim 1,
wherein the gear is exposed to an outside of the cover in the second direction in a region between the cover and the first outer surface in the first direction.

3. The developing cartridge according to claim 1,
wherein the cover includes:
an end wall opposing the first outer surface in the first direction; and
a peripheral wall extending from an outer peripheral end of the end wall toward the first outer surface in the first direction, and
wherein the aperture is positioned between the electrical contact surface and the developing roller in the second direction, the aperture being formed in a part of the peripheral wall.

4. The developing cartridge according to claim 2,
wherein the cover includes:
an end wall opposing the first outer surface in the first direction; and
a peripheral wall extending from an outer peripheral end of the end wall toward the first outer surface in the first direction, and
wherein the gear is exposed to the outside of the cover in the second direction through the aperture in a region between the end wall and the first outer surface in the first direction.

5. The developing cartridge according to claim 4,
wherein the electrical contact surface has:
a part positioned at the same position as the end wall in the first direction; and
a remaining part other than the part, at least a part of the remaining part being positioned at the same position as the aperture in the first direction.

6. The developing cartridge according to claim 4,
wherein the cover includes a holder,
wherein the end wall, the peripheral wall and the holder are formed as a single member, and
wherein the electrical contact surface is positioned at an outer surface of the holder.

7. The developing cartridge according to claim 6,
wherein the cover includes a rib extending in the first direction from the end wall, and
wherein the holder is connected to the end wall and the rib.

8. The developing cartridge according to claim 4,
wherein the cover includes:
an arm extending in a direction crossing the second direction; and
a holder positioned at a free end of the arm, and
wherein the electrical contact surface is positioned at an outer surface of the holder.

9. The developing cartridge according to claim 8,
wherein the arm extends from the peripheral wall toward the aperture.

10. The developing cartridge according to claim 4, further comprising a holder, the holder being a separate member from the cover and being fixed to the cover,
wherein the electrical contact surface is positioned at an outer surface of the holder.

11. The developing cartridge according to claim 10,
wherein the holder includes a protrusion in contact with the cover in the second direction.

12. The developing cartridge according to claim 10,
wherein the holder extends in a direction crossing the second direction, and
wherein a gap is formed between the holder and the cover in the second direction.

13. The developing cartridge according to claim 1, further comprising:
an agitator rotatable about an agitator axis extending in the first direction;
a coupling gear positioned at the first outer surface, the coupling gear being rotatable together with the coupling; and
an idle gear positioned at the first outer surface, the idle gear meshing with the coupling gear,
wherein the gear is an agitator gear connected to the agitator and meshing with the idle gear, and
wherein the agitator gear is exposed to an outside of the cover in the second direction in a region between the cover and the first outer surface in the first direction.

14. The developing cartridge according to claim 6,
wherein the housing has a second outer surface at an other end of the housing in the first direction, the second outer surface being spaced apart from the first outer surface in the first direction, and
wherein at least a part of the holder is positioned outside the housing when the developing cartridge is viewed in a direction from the second outer surface toward the first outer surface in the first direction.

15. The developing cartridge according to claim 4,
wherein the developing cartridge is attachable to and detachable from a drum cartridge, and
wherein, in a state where the developing cartridge is attached to the drum cartridge, a part of the drum cartridge is inserted in the aperture.

16. The developing cartridge according to claim 15,
wherein the housing has a pressing surface, the pressing surface being pressed by a pressing member of the drum cartridge in the state where the developing cartridge is attached to the drum cartridge, and
wherein the pressing surface is exposed to the outside of the cover through the aperture in the region between the end wall and the first outer surface in the first direction.
